(19) United States
(12) Patent Application Publication
(10) Pub. No.: US 2008/0254255 A1
(43) Pub. Date: Oct. 16, 2008

(54) GEL FOAM ELASTOMER AND METHOD OF MANUFACTURING SAID GEL FOAM ELASTOMER

(75) Inventor: Chen-I Kao, Huatan Township (TW)

Correspondence Address: EGBERT LAW OFFICES, 412 MAIN STREET, 7TH FLOOR, HOUSTON, TX, 77002, US

(73) Assignee: TAIWAN SEESUN INC., Huatan Township (TW)

(21) Appl. No.: 11/735,887

(22) Filed: Apr. 16, 2007

(51) Int. Cl. B32B 5/18; C08J 9/00

(52) U.S. Cl. 428/141; 521/52

(57) ABSTRACT

The present invention provides an innovative gel foam elastomer and method of manufacturing thereof, which blends raw gel with the powdery foaming/bridging agent, and then adds some assistants to begin the foaming procedure. The raw gel molecules and foaming agent molecules generate a bonding effect of virtual key or elastic key, thus forming a solid gel foam elastomer. The elastomer can be fabricated into various 3D structures, and also incorporated into the superficial layer or mat structure. The elastomer of the present invention overcomes the instability problem of existing liquid gel, but also maintains the excellent softness property, thus providing improved applicability for the industry and the users.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a gel foam elastomer, and more particularly to the gel foam elastomer and method of manufacturing thereof.

2. Description of Related Art Including Information Disclosed Under 37 CFR 1.97 and 37 CFR 1.98

A great number of commercially available pads or mats, such as mouse pads, yoga mats and sports mats, are filled with silica-gel materials to achieve highly soft and comfortable properties. However, some disadvantages for such gel pads are found in the application.

Referring to FIG. 1, if silica-gel materials are added into a mouse pad, then the first substrate 01 must be placed into a preformed mold 10 (e.g. by vacuum extraction). A dense gel 11 is filled into the depressed portion 03 on the first substrate 01, and a second substrate 02 is then sealed up by means of hot-pressing to position the gel 11 between the first and second substrates 01, 02. Thus, a finished mouse pad 12 is formed.

In addition to extremely complex processing procedures, the liquid gel 11 is difficult to fixed between the first and second substrates 01, 02, so some other reinforcement measures are required to prevent leakage of gel 11 from the gap joint, leading to much higher product cost and poorer economic efficiency. Given the fact that gel within existing gel mats cannot be reliably fixed in place, the liquid gel is prone to leak after a period of time. In such a case, the mats have to be discarded due to high viscosity of the gel. Thus, most typical gel mats have the disadvantages of shorter lifespan, poor durability and subsequent environmental impact.

Thus, to overcome the aforementioned problems of the prior art, it would be an advancement in the art to provide an improved structure that can significantly improve efficacy.

To this end, the inventor has provided the present invention of practicability after deliberate design and evaluation based on years of experience in the production, development and design of related products.

### BRIEF SUMMARY OF THE INVENTION

The present invention provides an innovative gel foam elastomer and method of manufacturing thereof. The present invention overcomes the instability problem of existing liquid gels, while simultaneously maintaining an excellent softness property. Since the gel foam elastomer in a solid state can be easily covered, positioned or preformed, as shown in FIG. 6, the manufacturing process can be simplified to save the cost without complex processing procedures. As for the users, the excellent softness property of the solid gel foam elastomer can provide outstanding comfort, but also prevent undesirable leakage of liquid gel, prolonging its service life with improved durability and applicability.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a schematic view of the prior art manufacturing process for typical gel mats.

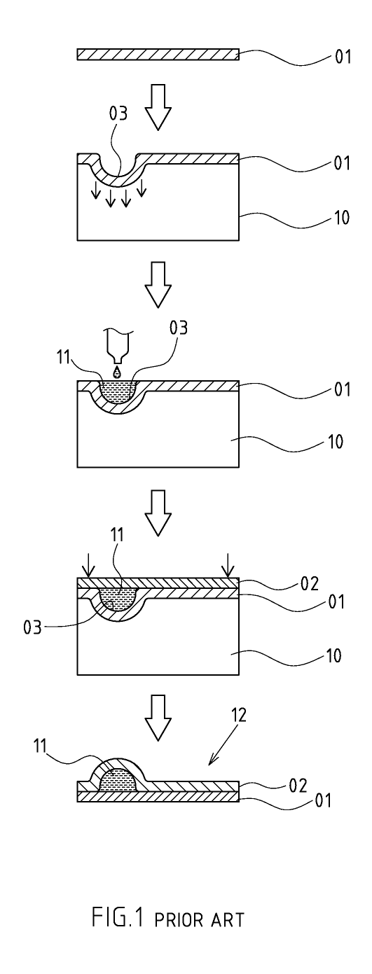

FIG. 2 shows a block diagram of the manufacturing method for the gel foam elastomer of the present invention.

FIG. 3 shows a schematic view of the manufacturing method of the gel-foam elastomer of the present invention.

FIG. 4 shows a schematic view of the bonding state of gel molecules and foaming/bridging agent molecules in the present invention.

FIG. 5 shows a schematic view of the gel foam elastomer of the present invention in a solid state but with a softness property.

FIG. 6 shows a cross-sectional view of the gel foam elastomer of the present invention, as applied to a yoga mat.

FIG. 7 shows a cross-sectional view of the gel foam elastomer of the present invention, as applied to a mouse pad.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

The gel foam elastomer and method of forming thereof are presented in the following preferred embodiment. The embodiments are provided for explanatory purposes only.

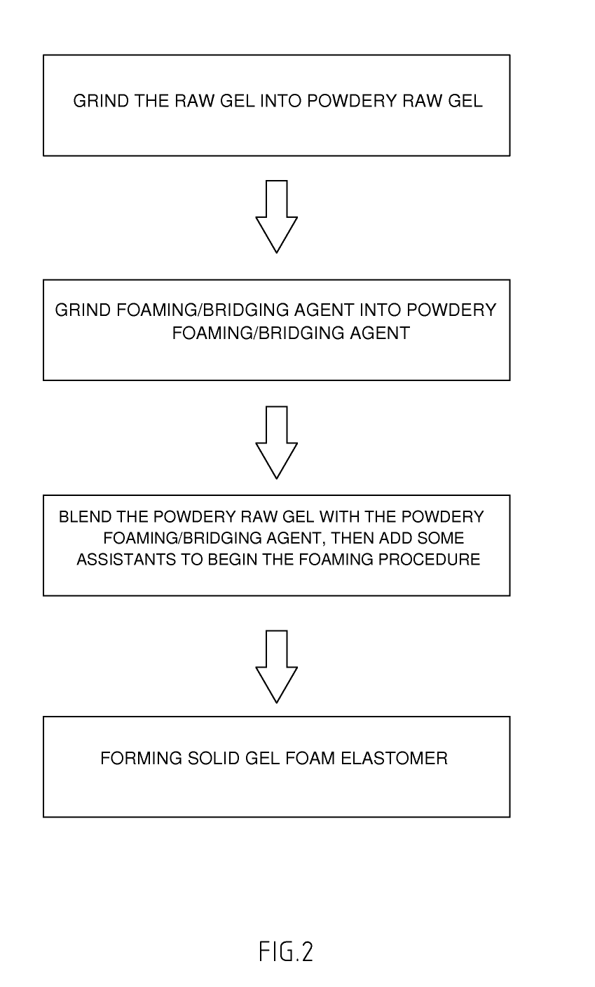

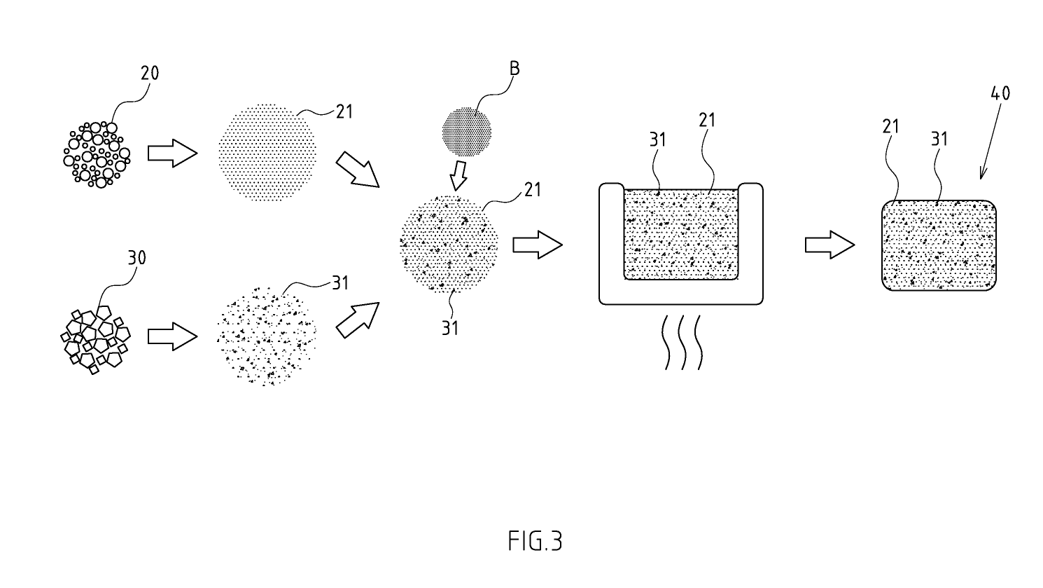

Referring to FIGS. 2 and 3, the method of manufacturing a gel foam elastomer includes the following steps:

grinding raw gel 20 (e.g. TPE) into a powdery raw gel 21, the raw gel being generally divided into granular or powdery gel;

grinding at least one foaming/bridging agent 30 (i.e. foaming agent and bridging agent being used interchangeably) into a powdery foaming/bridging agent 31, the foaming/bridging agent being divided into granular or powdery foaming/bridging agent;

blending the powdery raw gel 21 with the powdery foaming/bridging agent 31, adding assistants B, as shown in FIG. 3, to begin foaming with sulphur, the assistants contain an antioxidant, dispersant agent, filler, reinforcing agent, foaming assistant, bridging assistant, softening agent and a catalyst; and

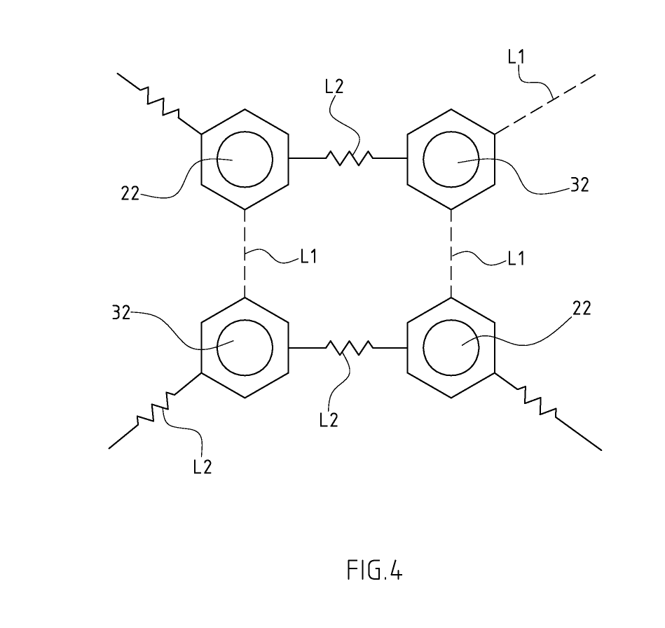

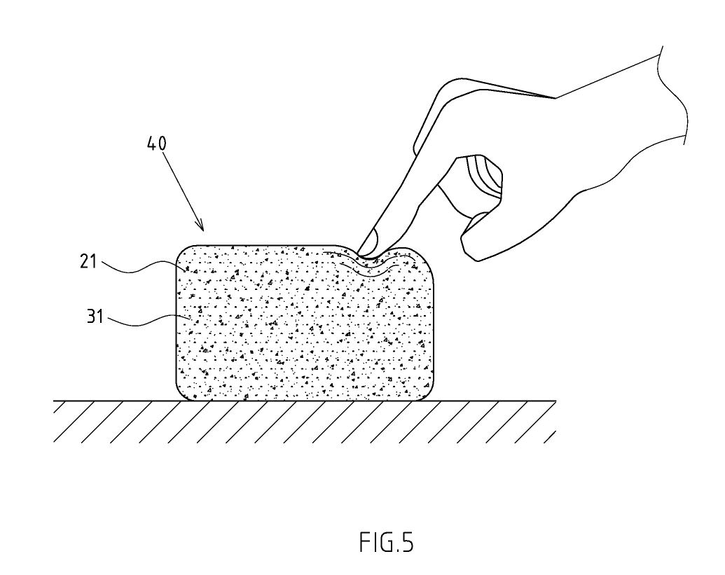

generating a bonding effect, as shown in FIG. 4, between the raw gel molecules 22 and agent molecules 32, having a virtual key L1 or elastic key L2, and forming solid gel foam elastomer 40 maintaining the softness property of liquid gel, as shown in FIG. 5.

When multiple foaming and bridging agents are employed, different reaction temperatures are optionally set for the foaming agent. Thus, the foaming agents with different reaction temperatures may yield various bonding states with the raw gel molecules to reach the desirable softness property. And, the bonding action of raw gel molecules allows the gel to change into a solid state.

The gel foam elastomer of the present invention shall be made of biodegradable TPE materials, which are more environmental-friendly than traditional PU or silicon materials. Also, the foaming loss of weight reduces the consumables and energy consumption, while also improving air quality compared to the traditional gel pouring process.

Next, the solid gel foam elastomer can be preformed into various shapes through the mold, while maintaining the softness property.

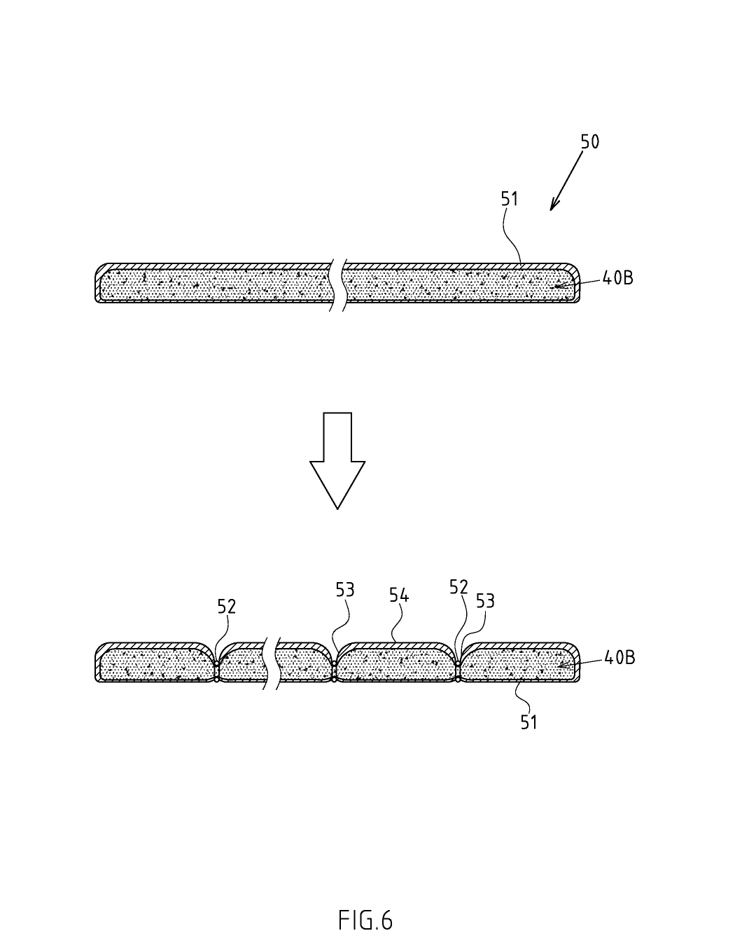

The gel foam elastomer of the present invention can be applied to a mat structure, for example, a yoga mat 50, as shown in FIG. 6. The gel foam elastomer product of the present invention includes:

at least a gel foam elastomer 40B, which is a solid body by mixing raw gel with a foaming/bridging agent, the gel foam elastomer being fabricated into a mat structure of predefined area and thickness, with the softness property of a gel; and

at least a superficial layer 51, which is partially or fully covered onto the gel foam elastomer 40B, the superficial layer 51 of the preferred embodiment being fully covered onto the gel foam elastomer 40B.

In the aforementioned preferred embodiments, depressed portions 53 are shaped at the predefined locations on the superficial layer 51 via the sewing line 52, while a convex portion 54 is defined between the depressed portions 53. Thus, the yoga mat 50 exhibits the same rugged surface of a conventional sofa mat or chair mat, presenting excellent air permeability and comfort.

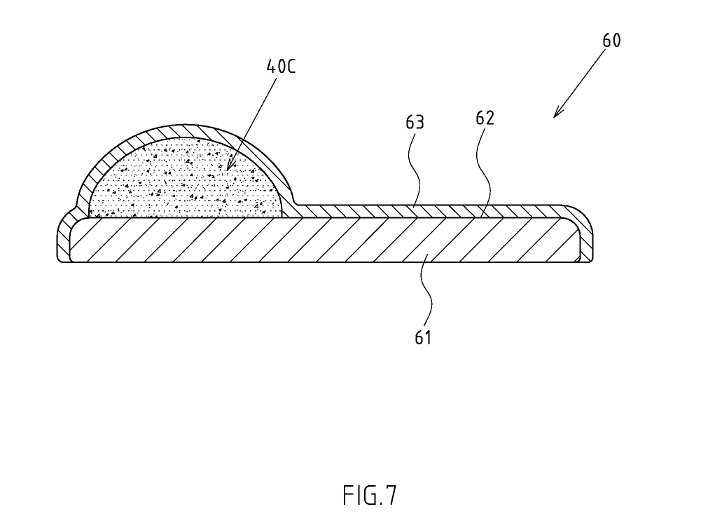

FIG. 7 depicts an example of another mat application, specifically, a mouse pad. The mouse pad 60 includes:

a mat body 61 of predefined area and thickness, which defines a mat surface 62;

a gel foam elastomer 40C, which is assembled onto the mat surface 62 of the mat body 61, the gel foam elastomer 40C being a solid body by mixing raw gel with a foaming/bridging agent and being fabricated into a predefined shape, similar to a hemispheric body, with a softness property from the gel; and

a superficial layer 63, which is covered onto the mat surface 62 of the mat body 61 to cover the gel foam elastomer 40C on the mat surface 62.

Additionally, the aforementioned mats could also be used as other sports mats.

1. A method of manufacturing a gel-foam elastomer, said method comprising the steps of:
grinding a raw gel into a powdery gel;
grinding at least one foaming/bridging agent into a powdery foaming/bridging agent;
blending the powdery raw gel with the powdery foaming/bridging agent and adding assistants to begin foaming with sulphur; and
generating bonding between raw gel molecules and agent molecules of virtual key or elastic key, thus forming a solid gel-foam elastomer.

2. The method defined in claim 1, wherein said step of generating bonding comprises setting different reaction temperatures the foaming agent when multiple foaming and bridging agents are employed.

3. The method defined in claim 1, wherein said assistants are selected from a group consisting of: antioxidant, dispersant agent, filler, reinforcing agent, foaming assistant, bridging assistant, softening agent and catalyst.

4. A structure comprising:
a gel foam elastomer, being formed by the method of claim 1, being shaped into a solid body and fabricated into a predefined mat.

5. A mat structure, comprising:
at least a gel-foam elastomer, being a solid body of mixed raw gel and a foaming/bridging agent and being fabricated into a mat structure of predefined area and thickness; and
at least a superficial layer, at least partially covered onto the gel-foam elastomer.

6. The mat structure defined in claim 5, wherein said superficial layer has a plurality of depressed portions shaped at the predefined locations thereon via a sewing line, said depressed portions defining a convex portion therebetween.

7. The mat structure defined in claim 5, wherein the gel foam elastomer is shaped as mouse pad, yoga mat and various sports mats.

8. A mat structure with gel-foam elastomer, comprising:
a mat body having a predefined area and thickness an a mat surface;
at least a gel-foam elastomer, being assembled onto said mat surface and being a solid body of mixed raw gel with foaming/bridging agent, the elastomer being fabricated into a predefined shape with a softness property of gel; and
at least a superficial layer, being covered onto said mat surface and covering the gel-foam elastomer on the mat surface.

9. The mat structure defined in claim 8, wherein the gel foam elastomer is shaped as mouse pad, yoga mat and various sports mats.
